(19) United States
(12) Patent Application Publication
(10) Pub. No.: US 2025/0197603 A1
(43) Pub. Date: Jun. 19, 2025

(54) REFRIGERATOR

(71) Applicant: Samsung Electronics Co., Ltd., Suwon-si (KR)

(72) Inventors: Toshiaki HIRANO, Yokohama-shi (JP); Kenji TAKEUCHI, Yokohama-shi (JP); Aiko MORI, Yokohama-shi (JP)

(73) Assignee: Samsung Electronics Co., Ltd., Suwon-si (KR)

(21) Appl. No.: 18/808,870

(22) Filed: Aug. 19, 2024

Related U.S. Application Data
(63) Continuation of application No. PCT/KR2024/011777, filed on Aug. 8, 2024.

(30) Foreign Application Priority Data
Dec. 15, 2023 (JP) 2023-212137

(51) Int. Cl. C08K 7/26; C08G 18/73; F25D 23/06

(52) U.S. Cl. CPC C08K 7/26; C08G 18/73; F25D 23/065; C08G 2110/0025; C08G 2330/00; C08K 2201/003

(57) ABSTRACT

A refrigerator may include a main body including: an inner cabinet that forms a storage room, an outer cabinet outside of the inner cabinet, and an insulation material between the inner cabinet and the outer cabinet; and a door configured to open and close the storage room, wherein the insulation material includes a rigid polyurethane foam that includes: fine particles that each include a surface layer including a hydrophobic group and a hydrophilic group, and a urethane resin containing a constituent unit derived from polyol and a constituent unit derived from isocyanate.

### CROSS-REFERENCE TO RELATED APPLICATIONS

This is a continuation application, under 35 U.S.C. § 111 (a), of International Application No. PCT/KR2024/011777, filed Aug. 8, 2024, which claims priority under 35 U.S.C. § 119 to Japanese Patent Application No. 2023-212137, filed Dec. 15, 2023, in the Japanese Intellectual Property Office, the disclosures of which are incorporated herein in their entireties by reference.

### TECHNICAL FIELD

The disclosure relates to a refrigerator including rigid polyurethane foam that is usable as an insulating material for home appliances such as refrigerators.

### BACKGROUND ART

In rigid polyurethane foam, when pores become excessively large, thermal conductivity increases. Therefore, in order to lower the thermal conductivity, it is necessary to suppress the excessive growth of pores.

Therefore, in order to make rigid polyurethane foam have lower thermal conductivity, as described in Patent Document 1 or 2, hollow fine particles consisting of aluminosilicate or hollow fine particles consisting of hydrophobic silica are contained in the rigid polyurethane foam, and it is thought that these fine particles physically suppress the growth of pores when the rigid polyurethane foam is foamed.

### PRIOR ART DOCUMENTS

### Patent Documents

Patent Document 1: Japanese Patent Publication No. 2021-102664
Patent Document 2: Japanese Patent Publication No. 2016-194034

### DISCLOSURE

### Technical Problem

In order to exhibit an effect of lowering thermal conductivity in rigid polyurethane foam described in Patent Document 1 or 2, the content of fine particles needs to be relatively increased to 3 wt % or more.

However, the present inventors have found through their studies that, in a case in which rigid polyurethane foam is to prepared by using hollow fine particles consisting of aluminosilicate as described in Patent Document 1, when an amount of fine particles for obtaining the above-described effect is to be contained in a polyol premix which is a material for rigid polyurethane foam, there is a problem that the fine particles themselves are hydrophilic, and thus as time passes after mixing, hydrophobic components (for example, cyclopentane or the like contained in the polyol premix as a foaming agent), which are dissolved or dispersed in the polyol premix, are separated, resulting in a decrease in foaming ratio of the rigid polyurethane foam.

In addition, the present inventors have found through their studies that, even in a case in which rigid polyurethane foam is to be prepared by using hydrophobic fine particles as described in Patent Document 2, when an amount of fine particles for obtaining the above-described effect is to be contained in a polyol premix which is a material for rigid polyurethane foam, even in this case, likewise, as time passes after mixing, the fine particles are separated from the polyol premix to make it difficult to uniformly disperse the fine particles, and as a result, the growth of pores may not be effectively suppressed.

The disclosure has been made in view of these problems, and a main objected of the disclosure is to provide a refrigerator including rigid polyurethane foam that has lower thermal conductivity than before while maintaining a sufficient foaming ratio.

### Technical Solution

That is, rigid polyurethane foam according to the disclosure is as follows.

According to an embodiment of the disclosure, a refrigerator may include a main body including: an inner cabinet that forms a storage room, an outer cabinet outside of the inner cabinet, and a insulation material between the inner cabinet and the outer cabinet; and a door configured to open and close the storage room, wherein the insulation material includes a rigid polyurethane foam that includes: fine particles that each include a surface layer including a hydrophobic group and a hydrophilic group, and a urethane resin containing a constituent unit derived from polyol and a constituent unit derived from isocyanate.

According to an embodiment of the disclosure, the surface layer includes a modifying group chemically bonded to a surface of the fine particle, and the modifying group, derived from a surface treatment agent, includes the hydrophobic group and the hydrophilic group.

According to an embodiment of the disclosure, the hydrophilic group may be an amino group or a hydroxyl group.

According to an embodiment of the disclosure, the hydrophobic group may be a C1-C10 straight-chain alkyl group.

According to an embodiment of the disclosure, the hydrophilic group may be between the hydrophobic group and the urethane resin.

According to an embodiment of the disclosure, the hydrophobic group may include a C4-C10 aryl group.

According to an embodiment of the disclosure, the fine particles may include an inorganic material.

According to an embodiment of the disclosure, the fine particles may be hollow particles or porous particles.

According to an embodiment of the disclosure, the surface treatment agent and the fine particles may include silicon.

According to an embodiment of the disclosure, the fine particles may each include: a core, a shell on the core, and a surface layer on the shell, and a density of the core may be less than a density of the shell.

According to an embodiment of the disclosure, the rigid polyurethane foam may include a framework including the urethane resin, and a plurality of pores defined by the framework, and the fine particles may be inside the framework and each fine particle may be spaced apart from a pore of the plurality of pores by at least the urethane resin.

According to an embodiment of the disclosure, the fine particles may each be fixed inside the framework through a chemical bond with the urethane resin.

According to an embodiment of the disclosure, the chemical bond may include a urea group, a urethane group, or a combination thereof.

According to an embodiment of the disclosure, a content of the fine particles may be in a range of 0.01 vol % to 0.5 vol % with respect to the rigid polyurethane foam.

According to an embodiment of the disclosure, a content of the fine particles may be in a range of 0.1 wt % to 1.5 wt % with respect to the rigid polyurethane foam.

According to an embodiment of the disclosure, an average particle diameter of the fine particles is in a range of 0.03 μm to 20 μm.

According to an embodiment of the disclosure, an apparent density of the fine particles is 200 kg/m³ or less.

According to an embodiment of the disclosure, the rigid polyurethane foam may further include a foaming agent including an organic compound.

According to an embodiment of the disclosure, the refrigerator may further include a cold air supply device configured to supply cold air to the storage room.

According to an embodiment of the disclosure, the refrigerator may further include: a machine room accommodating at least some parts of the cold air supply device; and a processor configured to control the refrigerator.

### Advantageous Effects

According to the disclosure, there may be provided a refrigerator in which thermal conductivity of rigid polyurethane foam is further lowered than before.

### DESCRIPTION OF DRAWINGS

FIG. 1 is a perspective view of a refrigerator according to an embodiment of the disclosure.

FIG. 2 is a front view illustrating the interior of a refrigerator according to an embodiment of the disclosure.

FIG. 3 is a schematic view illustrating the structure of a fine particle contained in rigid polyurethane foam according to an embodiment of the disclosure.

FIG. 4 shows schematic views illustrating a specific example of a modifying group that forms a surface layer of a fine particle contained in rigid polyurethane foam according to an embodiment of the disclosure.

FIG. 5 is a schematic view illustrating suppression of growth of pores in rigid polyurethane foam according to an embodiment of the disclosure.

FIG. 6 shows schematic views illustrating heat flow in rigid polyurethane foam according to an embodiment of the disclosure and rigid polyurethane foam according to related art.

FIG. 7 shows micrographs of rigid polyurethane foams according to Examples and Comparative Examples of the disclosure.

FIG. 8 is a graph showing a relationship between a content of fine particles and thermal conductivity of rigid polyurethane foam according to Examples and Comparative Examples of the disclosure.

### MODE FOR INVENTION

It should be appreciated that various embodiments of the disclosure and the terms used therein are not intended to limit the technological features set forth herein to particular embodiments of the disclosure and include various changes, equivalents, or replacements for a corresponding embodiment of the disclosure.

With regard to the description of the drawings, similar reference numerals may be used to refer to similar or related components.

It is to be understood that a singular form of a noun corresponding to an item may include one or more of the things, unless the relevant context clearly indicates otherwise.

As used herein, each of such phrases as “A or B,” “at least one of A and B,” “at least one of A or B” “A, B, or C,” “at least one of A, B, and C,” and “at least one of A, B, or C” may include any one of, or all possible combinations of the items enumerated together in a corresponding one of the phrases.

The term “and/or” includes a combination of a plurality of related described components items or any component of a plurality of related described components.

As used herein, such terms as “1st” and “2nd,” or “first” and “second” may be used to simply distinguish a corresponding component from another, and does not limit the components in other aspect (for example, importance or order).

In addition, the terms such as “front side,” “rear side,” “upper side,” “side,” “left,” “right,” “upper portion,” “lower portion” and the like used in the disclosure are defined based on drawings, and the shape and position of each component are not limited by this term.

The term “comprise” or “has” is used to specify existence of a feature, a number, a process, an operation, a component, a part, or a combination thereof described in the disclosure, and existence or additional possibility of one or more other features or numbers, processes, operations, components, parts, or combinations thereof are not excluded in advance.

An expression that one component is “connected,” “coupled,” “supported,” or “in contact” with another component includes a case in which the components are directly connected, coupled, supported, or in contact with each other and a case in which the components are indirectly connected, coupled, supported, or in contact with each other through a third component.

An expression that one component is referred to as being “on” or “over” another component includes a case in which the component is in contact with another component and a case in which another component is present between two components.

As used herein, unless otherwise defined, the term “size” of particles refers to the “particle diameter” of particles.

As used herein, the term “particle diameter” of particles refers to an average diameter when particles are spherical and refers to an average major axis length when particles are non-spherical. A particle diameter of particles may be measured by using a particle size analyzer (PSA). A “particle diameter” of particles is, for example, an “average particle diameter.” An “average particle diameter” is a median particle diameter (D50) unless explicitly stated otherwise. The median particle diameter (D50) refers to a particle size corresponding to a 50% cumulative value when a particle size calculated from particles having the smallest particle size in a cumulative distribution curve of particle sizes in which particles are accumulated in order of particle sizes from the smallest particles to the largest particles. The cumulative value may be, for example, a cumulative volume. The median particle diameter (D50) may be measured, for example, through a laser diffraction method. Alternatively, an “average particle diameter” may be measured from a scanning electron microscope (SEM) image or a transmission electron microscope (TEM) image through a manual or software.

In the disclosure, a “hydrophilic group” is a functional group that is attracted to water and tends to be dissolved by water. The hydrophilic group includes, for example, a hydroxyl group, a carboxyl group, or an amino group.

In the disclosure, a “hydrophobic group” is a functional group that is not attracted to water and tends not to be dissolved by water. The hydrophobic group includes, for example, an alkyl group or an aryl group.

In the disclosure, a “refrigerator” is a home appliance that supplies cold air generated by a compressor of a cold air supply device to a storage room to allow various foods to be kept fresh for a long period of time.

For example, the refrigerator may include a main body, and the main body may include an inner cabinet, an outer cabinet disposed outside the inner cabinet, and an insulating material provided between the inner cabinet and the outer cabinet.

In the disclosure, the “inner cabinet” is a member that forms a storage room. The inner cabinet may include, for example, a case, a plate, a panel, or a liner. For example, the inner cabinet may be formed as one body or may be formed by assembling a plurality of plates.

In the disclosure, the “outer cabinet” is a member that forms an exterior of the main body. The outer cabinet may be coupled to the outside of the inner cabinet such that the insulating material is disposed between the inner cabinet and the outer cabinet.

In the disclosure, the “insulating material” is a material that blocks or suppresses the transfer of heat. For example, the insulating material may insulate the inside of the storage room from the outside of the storage room such that a temperature inside the storage room may be maintained at a set appropriate temperature without being affected by an environment outside the storage room. The insulating material may include, for example, a foamed insulating material. For example, after the inner cabinet and the outer box are fixed with a jig or the like, urethane foam in which a urethane resin and a foaming agent are mixed may be injected and foamed between the inner cabinet and the outer cabinet, thereby arranging the foamed insulating material.

The insulating material may further include, for example, a vacuum insulating material in addition to the foamed insulating material. The insulating material may, for example, consist only of the vacuum insulating material instead of the foamed insulating material. The vacuum insulating material may include, for example, a core material and a shell material that accommodates the core material and seals the interior at a vacuum or a pressure close to vacuum. The vacuum insulating material may further include, for example, an adsorbent that adsorbs gas and moisture to stably maintain a vacuum state. The insulating material is not limited to the above-described foamed insulating material and/or vacuum insulating material, and any material may be used as long as the material is used as an insulating material in the art.

In the disclosure, the “storage room” is a space for storing items inside the refrigerator. The storage room may include, for example, a space defined by the inner cabinet. For example, the storage room may further include an inner cabinet that defines a space corresponding to the storage room. For example, various items such as food, medicine, and cosmetics may be stored in the storage room, and the storage room may be formed such that at least one side thereof is open for loading and unloading the items.

The refrigerator may include, for example, one or more storage rooms. When two or more storage rooms are formed in the refrigerator, respective storage rooms may have different purposes and may be maintained at different temperatures. To this end, the respective storage rooms may be partitioned from each other by a partition wall including an insulating material.

For example, the storage room may be provided to be maintained at an appropriate temperature range according to the purpose and may include a “refrigerating room,” a “freezing room” and/or a “temperature change room” which are distinguished from each other according to the use and/or temperature range thereof. For example, the refrigerating room may be maintained at a temperature that is appropriate for refrigerating items. For example, the freezing room may be maintained at a temperature that is an appropriate for freezing items.

In the disclosure, “refrigerating” means that items are cooled as cold as possible without being frozen. For example, the refrigerating room may be maintained in a range of 0 degrees Celsius to +7 degrees Celsius.

In the disclosure, “freezing” means that items are frozen or are cooled to be maintained in a frozen state. For example, the freezing room may be maintained in a range of −20 degrees Celsius to −1 degree Celsius.

The temperature change room may be used as any one of a refrigerating room or a freezing room according to a choice of a user or irrespective of the choice.

In addition to names such as the “refrigerating room,” “the freezing room,” and the “temperature change room,” the storage room may be called by various names such as a “vegetable room,” a “fresh room,” a “cooling room,” and an “ice-making room.” Terms such as the “refrigerating room,” “the freezing room,” and the “temperature change room” used below should be understood to encompass storage rooms with corresponding purposes and temperature ranges, respectively.

The refrigerator may include at least one door configured to open or close one open side of the storage room.

In the disclosure, the “door” is provided to open or close one or more storage rooms, or one door is a member provided to open or close a plurality of storage rooms. The door may be rotatably or slidingly installed on a front side of the main body.

For example, when the door is closed, the door may be configured to seal the storage room. Like the main body, the door may include, for example, an insulating material to insulate the storage room when the door is closed.

The door may include, for example, an outer door plate that forms a front side of the door, an inner door plate that forms a rear side of the door and faces the storage room, an upper cap, a lower cap, and a door insulating material provided inside the outer door plate, the inner door plate, the front side, the upper cap, and the lower cap.

For example, a gasket may be provided at an edge of the inner door plate to seal the storage room by coming into close contact with the front side of the main body when the door is closed. The inner door plate may include, for example, a dyke that protrudes rearward such that a door basket capable of storing items is mounted.

The door may include, for example, a door body and a front panel that is detachably coupled to the front of the door body and forms the front side of the door. The door body may include, for example, an outer door plate that forms a front side of the door body, an inner door plate that forms a rear side of the door body and faces the storage room, an upper cap, a lower cap, and a door insulating material provided inside the outer door plate, the inner door plate, the upper cap, and the lower cap.

Refrigerators may be classified into, for example, a french door type refrigerator, a side-by-aide type refrigerator, a bottom mounted freezer (BMF) refrigerator, a top mounted freezer (TMF) refrigerator, and a 1-door refrigerator according to the arrangement of a door and a storage room.

The refrigerator may include the cold air supply device configured to supply cold air to the storage room.

In the disclosure, the “cold air supply device” refers to a machine, an instrument, an electronic device, and/or a combination system thereof which is capable of generating cold air and guiding the cold air to cool the storage room.

The cold air supply device may generate cold air through a refrigeration cycle that includes refrigerant compression, condensation, expansion, and evaporation processes. To this end, the cold air supply device may include a compressor, a condenser, an expansion device, and an evaporator which are capable of driving the refrigeration cycle.

The refrigerator may include a machine room provided such that at least some parts belonging to the cold air supply device are disposed therein.

In the disclosure, the “machine room” refers to a space in which at least some parts belonging to the cold air supply device and the like are disposed. In order to prevent heat generated from the parts disposed in the machine room from being transferred to the storage room, the machine room may be provided to be partitioned and insulated from the storage room. In order to dissipate heat from the parts disposed inside the machine room, the inside of the machine room may be configured to communicate with the outside of the main body.

The refrigerator may further include a dispenser provided in the door to provide water and/or ice. The dispenser may be provided in the door such that a user may access the dispenser without opening the door.

The refrigerator may include an ice making device configured to form ice. The ice making device may include an ice making tray that stores water, an ice separating device that separates ice from the ice making tray, and an ice bucket that stores ice generated in the ice making tray.

The refrigerator may include a processor for controlling the refrigerator.

In the disclosure, the “processor” controls the overall operation of the refrigerator. The processor refers to a hardware device (chip) that includes an integrated circuit in which electrical circuits are integrated. The processor may control the components of the refrigerator by executing a program stored in a memory. The processor may include a separate neural network processing unit (NPU) that performs the operation of an artificial intelligence model. In addition, the processor may include a central processing unit, a graphics processor (GPU), or the like. The processor may generate a control signal for controlling the operation of the cold air supply device. For example, the processor may receive temperature information of the storage room from a temperature sensor and may generate a cooling control signal for controlling the operation of the cold air supply device based on the temperature information of the storage room.

In addition, the processor may process a user input of an user interface according to programs and/or data recorded/stored in the memory and may control the operation of the user interface. The user interface may be provided by using an input interface and an output interface. The processor may receive a user input from the user interface. In addition, in response to the user input, the processor may transmit a display control signal and image data, which are for displaying an image on the user interface, to the user interface.

In the disclosure, the “memory” stores or records various types of information, data, instructions, programs, and the like which are necessary to operate the refrigerator. The memory refers to a hardware device (chip) that includes an integrated circuit in which electrical circuits are integrated. The memory may store temporary data generated while control signals for controlling the components included in the refrigerator are generated. The memory may include at least one of a volatile memory or a non-volatile memory, or a combination thereof. The processor and the memory may be provided integrally or may be provided separately. The processor may include one or more processors. For example, the processor may include a main processor and at least one subprocessor. The memory may include one or more memories.

For example, the refrigerator may include a processor and a memory which control all of the components included in the refrigerator and may include a plurality of processors and a plurality of memories which individually control the components of the refrigerator. For example, the refrigerator may include a processor and a memory which control the operation of the cold air supply device according to the output of the temperature sensor. The refrigerator may separately include a processor and a memory which control the operation of the user interface according to a user input.

In the disclosure, a “control unit” refers to a part including a memory that stores or records programs and/or data for controlling the refrigerator, and a processor that outputs a control signal for controlling the cold air supply device or the like according to the programs and/or data recorded in the memory.

A communication module may communicate with external devices such as servers, mobile devices, and other home appliances through a nearby access point (AP). The AP may connect a local area network (LAN) to which the refrigerator or a user device is connected to a wide area network (WAN) to which a server is connected. The refrigerator or the user device may be connected to the server through the WAN.

The input interface may include a key, a touch screen, a microphone, or the like. The input interface may receive a user input and transmit the user input to the processor.

The output interface may include a display, a speaker, or the like. The output interface may output various notifications, messages, information, or the like generated by the processor. An embodiment of the disclosure will be described in detail below with reference to the drawings.

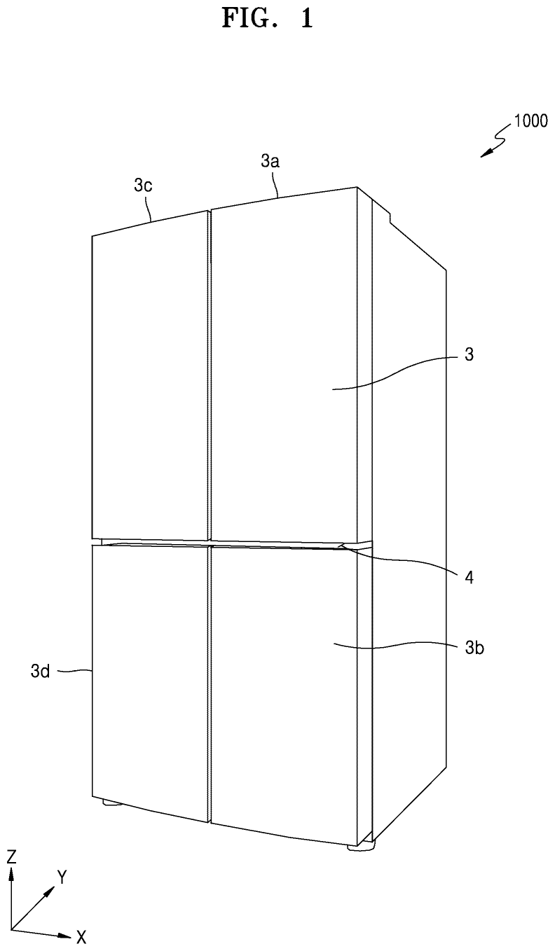

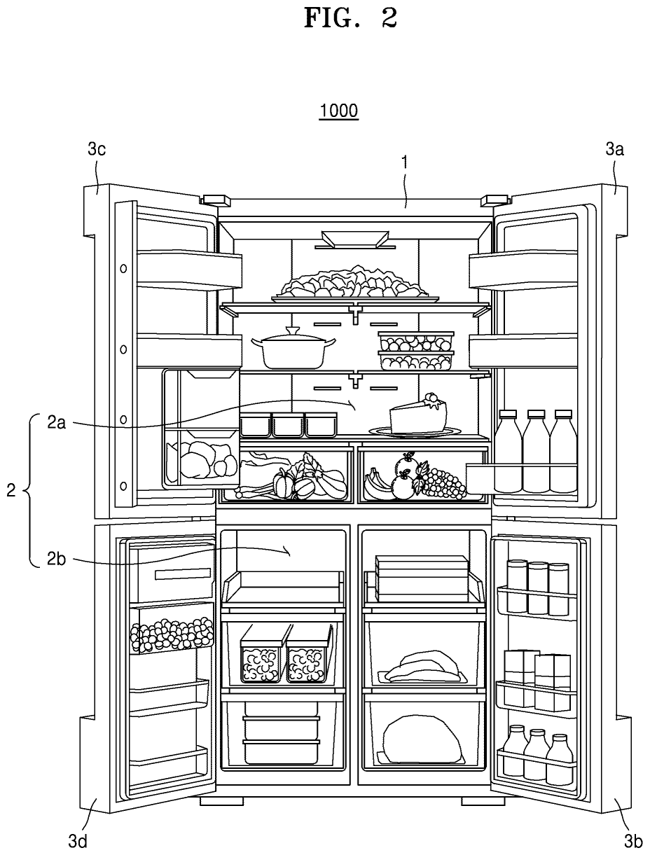

FIG. 1 is a perspective view of a refrigerator according to an embodiment of the disclosure. FIG. 2 is a front view illustrating the interior of the refrigerator according to an embodiment of the disclosure.

Referring to FIGS. 1 and 2, a refrigerator 1000 according to an embodiment of the disclosure includes a main body 1 having storage rooms 2 (2a and 2b), and doors 3 (3a, 3b, 3c, and 3d) coupled to the main body 1 to open or close the storage room.

The main body 1 of the refrigerator 100 may include an inner cabinet, an outer cabinet disposed outside the inner cabinet, and an insulating material disposed between the inner cabinet and the outer cabinet. Since the main body 1 includes the insulating material, a temperature inside the storage room 2 may be maintained at a set appropriate temperature without being affected by an external environment of the storage room. The refrigerator 1000 includes the doors 3 (3a, 3b, 3c, and 3d) configured to open or close one open side of the storage room 2. Although the refrigerator 1000 is illustrated as including four doors 3, the number of doors 3 is not limited thereto. An upper door 3a and a lower door 3b at a right side of the refrigerator 1000 may be provided as one door, and an upper door 3c and a lower door 3d at a left side of the refrigerator 1000 may be provided as one door. In addition, the refrigerator 1000 may have more or less than four doors. In addition, a position of the door 3 may also be changed in various ways. A knob area 4, which is a separation space into which a user may insert his/her hand to open or close the door 3, may be present between a plurality of doors 3a, 3b, 3c, and 3d. The door 3 may be configured to seal the storage room when the door 3 is closed. Like the main body 1, the door 3 may include an insulating material to insulate the storage room 2 when the door 3 is closed.

The insulating material includes rigid polyurethane foam. The rigid polyurethane foam includes fine particles and a urethane resin including a constituent unit derived from polyol and a constituent unit derived from isocyanate. The fine particles each include a surface layer, and the surface layer includes both a hydrophobic group and a hydrophilic group.

The surface layer of the fine particles may include both the hydrophobic group and the hydrophilic group, a balance between hydrophilicity and hydrophobicity in a polyol premix including the fine particles may not collapse, thereby suppressing phase separation and achieving more uniform dispersion of the fine particles. Accordingly, the rigid polyurethane foam prepared from the polyol premix may have a smaller size and may include more uniform pores. As a result, the insulation effect of a refrigerator provided with an insulating material including the rigid polyurethane foam may be further improved. For example, a thickness of an insulating material may be reduced to increase a storage room.

The surface layer of the fine particles may include both the hydrophobic group and the hydrophilic group, and thus in the rigid polyurethane foam, the fine particles may be disposed inside a framework, which includes a urethane resin, through a chemical bond with the urethane resin. Therefore, in the rigid polyurethane foam, heat conduction through the framework including the urethane resin may be more effectively blocked or suppressed. As a result, the insulation effect of a refrigerator provided with an insulating material including the rigid polyurethane foam may be further improved. For example, the weight of an insulating material may be further reduced by reducing the content of fine particles used in polyurethane foam.

### Configuration of Rigid Polyurethane Foam According to Embodiment of the Disclosure

Rigid polyurethane foam according to an embodiment of the disclosure is polyurethane foam foamed and cured to form a plurality of pores therein, specifically, independent pores. The overall density of the rigid polyurethane foam may be in a range of 30 kg/m³ to 45 kg/m³, 32 kg/m³ to 40 kg/m³, or 32 kg/m³ to 38 kg/m³.

The rigid polyurethane foam contains a urethane resin consisting of a constituent unit derived from polyol and an constituent unit derived from isocyanate, a foaming agent that forms the above-mentioned pores, and fine particles.

In addition, the rigid polyurethane foam is urethane foam that loses recovery and cushioning properties after curing and is often used for thermal insulation purposes.

Examples of the polyol may include polyether polyol and/or polyester polyol.

Specifically, the constituent unit derived from the polyol contains a constituent unit (also referred to as a first constituent unit) derived from an aromatic amine compound, to which both ethylene oxide and propylene oxide are added, such as an aromatic amine compound having 2 to 6 functional groups. Specific examples of the aromatic amine compound constituting the first constituent unit may include 2,3-toluenediamine, 2,4-toluenediamine, and 2,6-toluenediamine. The content of the first constituent unit may be in a range of 65 wt % to 99 wt % with respect to 100 wt % of all of the constituent unit derived from the polyol.

The constituent unit derived from the polyol may further contain a constituent unit (also referred to as a second constituent unit) derived from an aliphatic non-amine-based compound, to which ethylene oxide is added, such as an aliphatic non-amine-based compound having 2 to 4 functional groups. Specific examples of the aliphatic non-amine compound constituting the second constituent unit may include ethylene glycol, propylene glycol, glycerin, and pentaerythritol. In this case, the content of the second constituent unit may be in a range of 1 wt % to 10 wt % with respect to 100 wt % of all of the constituent unit derived from the polyol. The constituent unit derived from the polyol may contain the aliphatic non-amine-based compound in the above-described range, and thus steric hindrance caused by an aromatic ring may be suppressed, thereby improving the strength of a pore film. As a result, it is considered that the thermal conductivity of rigid polyurethane foam containing fine particles may be further lowered because pores may be made finer, and also, high gas barrier properties may be imparted.

The constituent unit derived from the polyol may contain the above-described first constituent unit and a constituent unit (also referred to as a third constituent unit) derived from a compound, to which diol is added, such as an aromatic dicarboxylic acid having 2 to 4 functional groups. Specific examples of the aromatic dicarboxylic acid constituting the third constituent unit may include a phthalic anhydride, a terephthalic acid, and the like. Examples of the diol may include diethylene glycol, 1,4-butanediol, 1,3-propanediol, 3-methyl-1,5-pentanediol, and the like. In this case, with respect to 100 wt % of all of the constituent unit derived from the polyol, the first constituent unit may be contained in a range of 65 wt % to 99 wt %, and the third constituent unit may be contained in a range of 1 wt % to 10 wt %. The constituent unit derived from the polyol may contain the first constituent unit and the third constituent unit, and thus aromatic rings of the constituent units are stacked on each other, thereby further improving the strength of a pore film. As a result, it is considered that the thermal conductivity of rigid polyurethane foam containing fine particles may be further lowered because pores may be made finer, and also, high gas barrier properties may be imparted.

In addition, the names of the above-described first constituent unit, second constituent unit, and third constituent unit are given for convenience, and for example, when the third constituent unit is contained, it does not have a special meaning such as necessarily containing the first constituent unit or the second constituent unit as a prerequisite.

As the isocyanate, any material used in rigid polyurethane foam in the past may be widely used, but for example, polymeric diphenylmethane diisocyanate (MDI) may be used.

As the foaming agent, any foaming agent may be used as long as the foaming agent is used in preparing rigid polyurethane foam, but specifically, for example, an organic solvent with a relatively low boiling point may be used as the foaming agent. Specifically, there may be a foaming agent with a boiling point of 55° C. or less, or a foaming agent with a boiling point of 50° C. or less may be used. In an embodiment of the disclosure, cyclopentane is used as an example of such a foaming agent.

The rigid polyurethane foam according to an embodiment of the disclosure may further contain additives such as a catalyst or a surfactant (binder) in addition to the above-described components.

Examples of the catalyst may include a gelling catalyst, a blowing catalyst, a trimerization catalyst, and the like. When these catalysts contain tertiary amine, polyurethane foam may be prepared as environmentally friendly as possible while manufacturing costs are reduced.

As the surfactant, any material used in rigid polyurethane foam in the past may be widely used, but for example, silicon-based surfactant may be used.

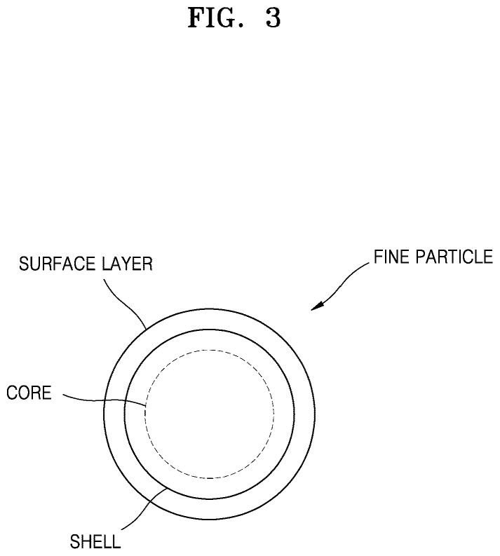

As shown in FIG. 3, the fine particles contained in the rigid polyurethane foam according to an embodiment of the disclosure each include an air layer (core), a shell with a spherical or polygonal shape, and a surface layer formed to cover a surface of the shell.

The fine particle may include the core, the shell disposed on the core, and the surface layer disposed on the shell, and the density of the core may be lower than the density of the shell.

The shell may consist of an inorganic material with excellent strength or heat resistance, and for example, there may be hollow particles, porous particles, an aerogel, an xerogel, and the like which are consist of an oxide such as silica or alumina.

The surface layer has both a hydrophobic group and a hydrophilic group. The surface layer is formed by a modifying group that is fixed to the above-described shell through a chemical bond such as a covalent bond and has both a hydrophobic group and a hydrophilic group.

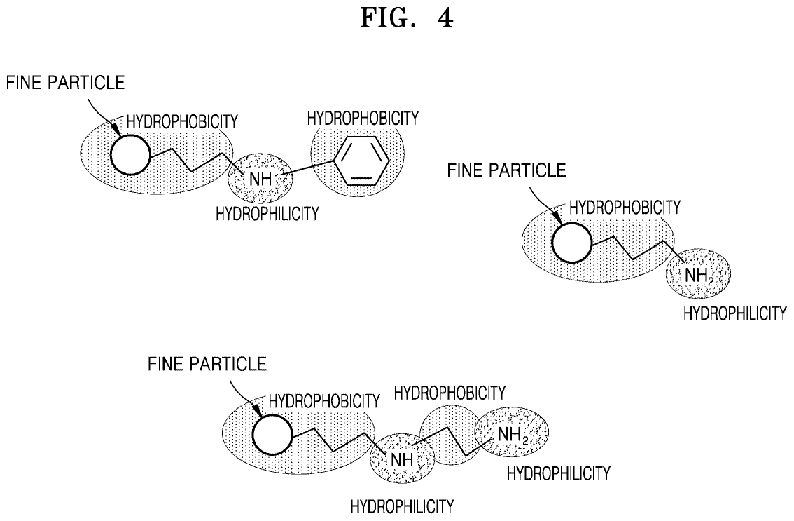

As the modifying group, any material is not particularly limited as long as the material has at least one hydrophobic group and at least one hydrophilic group, but as shown in FIG. 4, specifically, the modifying group is a straight-chain type in which a bonding group for chemically bonding the shell and the modifying group, a hydrophobic group, and a hydrophilic group are bonded in this stated order from a side that is close to the shell. In addition, a structure may be possible in which a bonding group, a hydrophobic group, and a hydrophilic group are arranged from the side that is close to the shell, and then a hydrophobic group is additionally present, or pairs of hydrophobic groups and hydrophilic groups are repeated.

The surface layer may consist of only one type of a modification group as described above or may include two or more types of modification groups as described above.

As the bonding group, any material may be used as long as the material may chemically bond the shell and the modifying group. For example, when the shell consists of silica, a silane compound such as trimethoxysilane may be used.

Examples of the hydrophobic group may include a cyclic hydrocarbon group of a C1-C10 straight-chain type or benzene ring such as an ethyl group, a methyl group, or a propyl group. The hydrophobic group may further include, for example, a C4-C10 aryl group.

The hydrophilic group may have, for example, an amino group or a hydroxyl group.

One modifying group derived from a surface treatment agent with one molecule may include one or more types of hydrophobic groups among those described above and one or more types of hydrophilic groups. In addition, when a plurality of types of hydrophobic groups and/or hydrophilic groups are included in one modifying group, and there is a structure in which a bonding group is disposed at the beginning, and subsequent to the bonding group, a hydrophobic group and a hydrophilic group are arranged alternately, the number of these groups and order that these groups are arranged is not limited by the disclosure.

The surface layer as described above may be formed, for example, by surface-treating the shell by using a surface treatment agent such as a silane coupling agent having both a hydrophobic group and a hydrophilic group in one molecule. The surface treatment agent may include the same element as the fine particle, and the same element may include silicon. More specifically, the surface layer may be formed by chemically bonding a surface of the shell and the surface treatment agent to each other through a covalent bond or the like such that a plurality of modifying groups are disposed to cover the surface of the shell. When the surface treatment agent is a straight-chain type, a modifying group derived from the surface treatment agent may be disposed to extend outward from the surface of the shell. The surface layer may have a hydrophobic group and a hydrophilic group, and the hydrophilic group may be disposed between the hydrophobic group and the urethane resin. For example, the hydrophobic group may be disposed on the fine particle, the hydrophilic group may be disposed on the hydrophobic group, and the urethane resin may be disposed on the hydrophilic group.

From the viewpoint that the thermal conductivity of the rigid polyurethane foam is lowered as much as possible, the thermal conductivity of the fine particles may be lower than that of the urethane resin. The thermal conductivity of the fine particles may be, for example, 50 mW/m·K or less, 30 mW/m·K or less, or 20 mW/m·K or less. The thermal conductivity of the fine particles may be 90% or less, 80% or less, 70% or less, 50% or less, or 30% or less of the thermal conductivity of the urethane resin.

The apparent density of the fine particles may be 200 kg/m³ or less or 150 kg/m³ or less. When the apparent density of the fine particles is 200 kg/m³ or less, the viscosity of the polyol mix may not be excessively high, and thus the generation of voids may be further suppressed. As the apparent density of the fine particles decreases, the thermal insulation performance of the rigid polyurethane foam may improves, and thus as the apparent density of the fine particles is lowered, it may be better.

In addition, apparent density may be obtained by putting 100 g of a fine particle powder into a measuring cylinder, leveling an upper side, reading an apparent volume V₀ (unit: ml) to obtain apparent density (g/ml), and performing unit conversion on the obtained apparent density.

The average particle diameter of the fine particles may be in a range of 0.03 μm to 20 μm, 0.05 μm to 10 μm, or 0.04 μm to 5 μm. When the average particle diameter of the fine particles is 0.03 μm or more, an effect of suppressing the growth of pores due to the presence of the fine particles may be sufficiently exhibited. In addition, when the average particle diameter of the fine particles is 20 μm or less, the number of fine particles contained in the rigid polyurethane foam may be sufficiently secured to sufficiently exhibit an effect of suppressing the growth of pores. The average particle diameter of fine particles may be measured through observation using a SEM.

In addition, a shape of the fine particles may be any shape such as a spherical shape, a spheroidal shape, other geometric shapes, an irregular shapes, or the like and may be, for example, a spherical or oval shape. A shape coefficient, which is the quotient obtained by the sum of an aspect ratio and an unevenness coefficient by 2, may be, for example, 120 or less, 115 or less, 110 or less, or 105 or less, wherein the aspect ratio is a value obtained by a length of a major axis divided by a length of a minor axis, and the unevenness coefficient is a value obtained by dividing a cross-sectional area of a plane including major and minor axes by the square of a perimeter length.

In the rigid polyurethane foam according to an embodiment of the disclosure, the content of the fine particles may be, for example, in a range of 0.01 vol % to 1.0 vol %, or 0.05 vol % to 0.5 vol % with respect to 100 vol % of the total volume of the rigid polyurethane foam.

By setting the content of the fine particles to 0.01 wt % or more, the number of particles per pore may be 1 or more, and thus pores may be reliably refined. In addition, by setting the content of the fine particles to 1.0 vol % or less, the viscosity of the polyol mix, which is a material for rigid polyurethane foam before foaming and curing, containing polyol or the like, may be suppressed from becoming excessively high, thereby suppressing an increase in thermal conductivity due to large pores generated in urethane foam being formed as voids without being removed.

In addition, the viscosity of the polyol premix may be adjusted according to a type of a used polyol mix or isocyanate other than those described above. For example, the viscosity of the polyol premix may be in a range of 500 mPa·s to 2,000 mPa-s, 500 mPa·s to 1,500 mPa·s, or 700 mPa-s to 1,300 mPa-s.

### Method of Preparing Rigid Polyurethane Foam According to an Embodiment of the Disclosure

The rigid polyurethane foam according to an embodiment of the disclosure may be prepared, for example, according to the following order and processes.

First, a mixed liquid including polyether polyol and/or polyester polyol is prepared, the mixed liquid and fine particles are mixed at room temperature and open to the atmosphere, and then a foaming agent is added and mixed in a closed space at a temperature of 20° C. to 25° C. to prepare a polyol premix.

After isocyanate is added to the polyol premix and stirred, the mixture is poured into an appropriate mold and freely foamed at an appropriate temperature, thereby preparing the rigid polyurethane foam.

The polyol premix may further include a foaming auxiliary agent, and when the foaming auxiliary agent is contained, the content of the foaming auxiliary agent in the polyol premix may be in a range of 0.5 wt % to 2.0 wt %. The foaming auxiliary agent is not particularly limited, but water may be used from the viewpoint that both high reaction efficiency and low costs may be achieved.

### Effects of Embodiment of the Disclosure

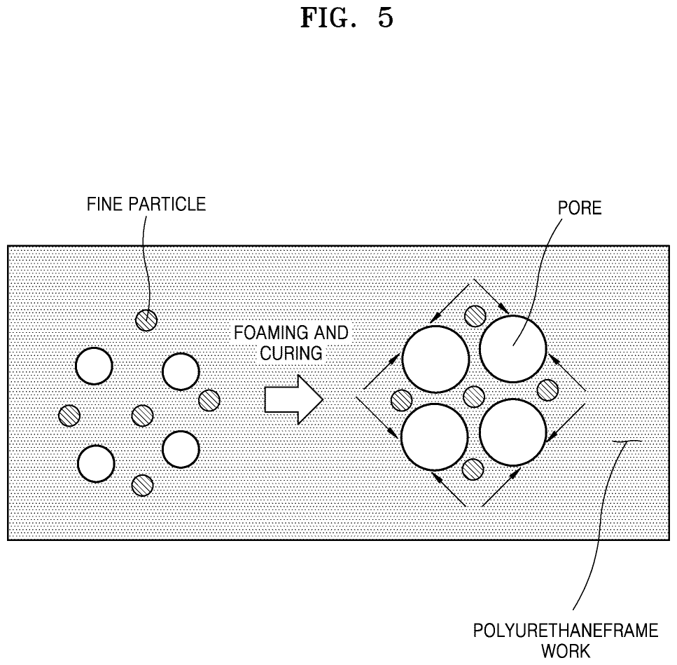

According to the rigid polyurethane foam according to an embodiment of the disclosure, since the fine particle has the surface layer having the hydrophobic group and the hydrophilic group, even when the fine particle is contained in the polyol premix, a balance between hydrophilicity and hydrophobicity in the polyol premix may not collapse, thereby preventing the separation of hydrophobic components or the fine particles. As a result, as shown in FIG. 5, the sizes of pores may be made small and uniform throughout the rigid polyurethane foam.

In addition, when the number of hydrophilic groups contained in the surface layer is large, the formation of chemical bonds for forming a urethane resin may further promoted to promote the curing of the urethane resin, thereby curing the urethane resin before pores become excessively large and more effectively suppressing the growth of pores.

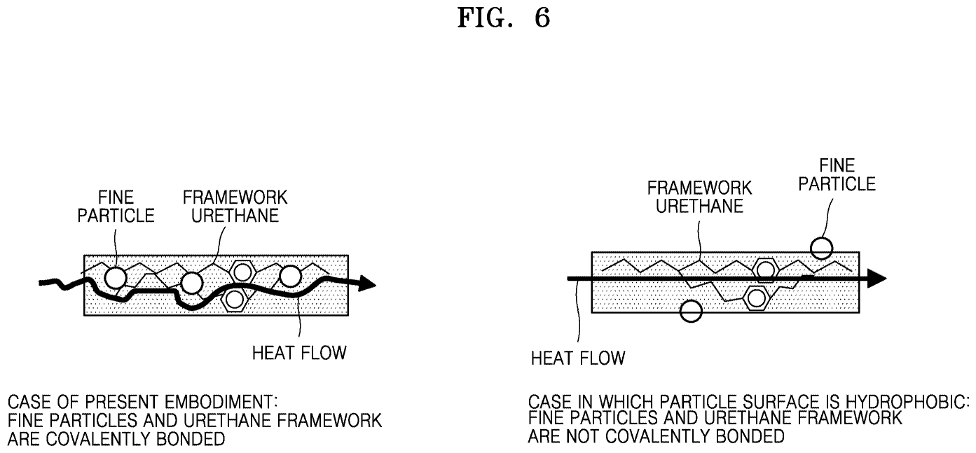

Referring to FIG. 6, the rigid polyurethane foam may include, for example, a framework including the urethane resin, and a plurality of pores defined by the framework, and may include the fines particles spaced apart from the pores and disposed inside the framework. The fine particles may be fixed inside the framework through a chemical bond with the urethane resin. The chemical bond may include a urea group, a urethane group, or a combination thereof.

The hydrophilic group included in the above-described modifying group may form a direct chemical bond with a urethane resin through a urethane bond or a urea bond. Therefore, the fine particles with lower thermal conductivity than the urethane resin may be introduced into a urethane framework forming the urethane resin, and as shown in FIG. 6, it may make it difficult for heat, which has been transmitted in the past along a urethane framework of a urethane resin, to be transmitted.

The surface layer may be formed by a straight-chain modifying group in which hydrophobic and hydrophilic groups appear in this stated order from a side that is close to the shell, and furthermore, by a modifying group with a structure in which hydrophobic and hydrophilic groups appear repeatedly, and thus the hydrophilic group contained in the modifying groups may easily access to polyol or isocyanate, which may make it easy for the fine particles to be introduced into the urethane framework.

According to the rigid polyurethane foam containing the fine particles according to an embodiment of the disclosure, the fine particles are contained in a ratio of 0.05 vol % to 0.35 vol % to 100 vol % of the rigid polyurethane foam containing the fine particles after foaming and curing, thereby avoiding an excessive increase or decrease in the number of fine particles contained per volume of the rigid polyurethane foam. In addition, even when a type of fine particles is changed, the number of fine particles required to refine pores may be present in the rigid polyurethane foam containing the fine particles, thereby suppressing the growth of pores during foaming.

The rigid polyurethane foam containing the fine particles according to an embodiment of the disclosure may be used as an insulating material for various purposes. Thermal conductivity may be sufficiently low, and manufacturing costs may be suppressed to an appropriate range so that the rigid polyurethane foam may be appropriately used as, for example, an insulating material for home appliances such as refrigerators.

The rigid polyurethane foam containing the fine particles has lower thermal conductivity than before, and thus even when the rigid polyurethane foam is thinner than before, thermal insulation performance equivalent to that of a related art may be achieved. In addition, as a result, when an insulating material is used between an outer cabinet (outer box) and an inner cabinet (inner box) of a refrigerator, the thickness of a heat insulating layer between the outer cabinet (outer box) and the inner cabinet (inner box) may be reduced, thereby increasing the volume of the interior (refrigerating room) of the inner cabinet than before.

Hereinafter, the definition of a substituent used in Formulas will be described.

As used in formulas, the term “alkyl” refers to a fully saturated branched or unbranched (or straight-chain or linear) hydrocarbon.

Non-limiting examples of the “alkyl” may include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, and n-heptyl.

At least one hydrogen atom of the “alkyl” may be substituted with a halogen atom, a C1-C30 alkyl group substituted with a halogen atom (for example, CCF₃, CHCF₂, CH₂F, or CCl₃), a C1-C30 alkoxy, a C2-C30 alkoxyalkyl, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid or a salt thereof, a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C3-C30 heteroaryloxy alkyl group, or a C6-C30 heteroarylalkyloxy group.

The term “alkylene” used in formulas refers to “alkyl” which is a diradical, and the alkyl is as described above. The diradical is, for example, an alkyl group that requires two connection points. For example, an alkylene group includes diradicals such as —CH₂—, —CH₂CH₂—, and —CH₂CH(CH₃)CH₂—.

Non-limiting examples of the “alkylene” may include methylene, ethylene, n-propylene, isopropylene, n-butylene, isobutylene, sec-butylene, n-pentylene, isopentylene, neopentylene, n-hexylene, 3-methylhexylene, 2,2-dimethylpentylene, 2,3-dimethylpentylene, and n-heptylene.

As used in formulas, the term “aryl” group is used alone or in combination and refers to an aromatic hydrocarbon containing one or more rings. The carbon number of the aryl group is, for example, in a range of 4 to 20, 4 to 15, or 4 to 10.

The term “aryl” also includes a group in which an aromatic ring is fused to at least one cycloalkyl ring.

Non-limiting examples of the “aryl” include phenyl, naphthyl, and tetrahydronaphthyl.

In addition, at least one hydrogen atom in the “aryl” may be substituted with the same substituent as in the case of the alkyl group described above.

The disclosure is not limited to the above-described embodiment of the disclosure of the disclosure, and various modifications or combinations of embodiments of the disclosure may be made as long as the objects of the disclosure are not impaired.

### EXAMPLES

Hereinafter, the disclosure will be described in more detail through specific examples. However, the following examples are merely examples of the disclosure, and the disclosure is not limited to the following examples.

First, each of mixed liquids as shown in Table 1 or Table 2 below was prepared. In Examples and Comparative Examples, the viscosities of polyol premixes measured at a temperature of 20° C. by using TVC-10 manufactured by Toki Sangyo Co., Ltd. were all 950 mPa·s. The mixture, of which a liquid temperature was adjusted to 25° C., was stirred at a speed of 5,000 rpm for 4 seconds by using a hand mixer. Afterwards, the mixture was poured into a wooden box having a size of 300 mm×300 mm×30 mm and freely foamed, thereby preparing rigid polyurethane foams of Examples and Comparative Examples. Table 1 shows the content of chemical components including fine particles with respect to all of the rigid polyurethane foam in wt % for Examples and Comparative Examples, and Table 2 shows the content of the fine particles with respect to all of the rigid polyurethane foam after foaming in vol % for Examples and Comparative Examples shown in Table 1.

TABLE 1

| | Examples [symbol] | | | | | | | | | Comparative Examples [symbol] | | | | |
|---|---|---|---|---|---|---|---|---|---|---|---|---|---|---|
| [symbol] | 1 [symbol] | 2 [symbol] | 3 [symbol] | 4 [symbol] | 5 [symbol] | 6 [symbol] | 7 [symbol] | 8 [symbol] | 9 [symbol] | 10 [symbol] | 11 [symbol] | 12 [symbol] | 13 [symbol] | 14 [symbol] |
| Polyol [symbol] | 40.1 [symbol] | 39.93 [symbol] | 39.76 [symbol] | 3 [symbol] . [symbol] 5 [symbol] | 40.04 [symbol] | 39.93 [symbol] | 39.82 [symbol] | 40.1 [symbol] | 40.01 [symbol] | 40.22 [symbol] | 40.04 [symbol] | 39.93 [symbol] | 40.17 [symbol] | 40.27 [symbol] |
| Foaming | 5.98 [symbol] | 5.96 [symbol] | 5.93 [symbol] | 5. [symbol] [symbol] | — [symbol] | 5.9 [symbol] [symbol] | 5.94 [symbol] | 5.98 [symbol] | 5.97 [symbol] | 6 [symbol] | 5.98 [symbol] | 5.98 [symbol] | 5. [symbol] [symbol] | 6.01 [symbol] |
| Agent [symbol] | | | | | | | | | | | | | | |
| Isocya- | 53.5 [symbol] | 53.27 [symbol] | 53.05 [symbol] | 53.3 [symbol] | 53.43 [symbol] | 53.28 [symbol] | 53.13 [symbol] | 53.5 [symbol] | 53.39 [symbol] | 53.6 [symbol] [symbol] | 53.43 [symbol] | 53.27 [symbol] | 53. [symbol] [symbol] | 53.73 [symbol] |
| nate [symbol] | | | | | | | | | | | | | | |
| Fine | 0.42 [symbol] | 0.85 [symbol] | 1.27 [symbol] | 0.81 [symbol] | 0.5 [symbol] [symbol] | 0.85 [symbol] | 1.13 [symbol] | — [symbol] | — [symbol] | — [symbol] | 0.57 [symbol] | 0.85 [symbol] | — [symbol] | — [symbol] |
| particles | | | | | | | | | | | | | | |
| A [symbol] | | | | | | | | | | | | | | |
| Fine | — [symbol] | — [symbol] | — [symbol] | — [symbol] | — [symbol] | — [symbol] | — [symbol] | 0.43 [symbol] | 0.64 [symbol] | 0.14 [symbol] | — [symbol] | — [symbol] | 0. [symbol] [symbol] | — [symbol] |
| particles | | | | | | | | | | | | | | |
| B [symbol] | | | | | | | | | | | | | | |
| Sum [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] |
| Surface | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] | [symbol] [symbol] |
| modifi- | | | | | | | | | | | | | | |
| cation of | | | | | | | | | | | | | | |
| fine par- | | | | | | | | | | | | | | |
| ticles [symbol] | | | | | | | | | | | | | | |

[symbol]

indicates data missing or illegible when filed

The specific details of each component in Table 1 are as follows.

Polyol: 70 wt % of aromatic amine-based polyol, 30 wt % of sorbitol-based polyol, 3.0 wt % of tertiary amine catalyst, 2.5 wt % of silicon-based surfactant, 1.8 wt % of water.
foaming agent: cyclopentane: “Marukazole FH” manufactured by Maruzen Petrochemical Co., Ltd
Isocyanate: MR200 Index110 manufactured by Tosoh
Fine particle shell A: hollow silica with apparent density of 90 kg/m³ to 140 kg/m³ and average particle diameter (D50) of 2 μm
Fine particle shell B: hollow silica with apparent density of 40 kg/m³ to 90 kg/m³ and average particle diameter (D50) of 0.1 μm
Surface modification I: 3-(N-phenyl)aminopropyltrimethoxysilane
Surface modification II: aminopropyltrimethoxysilane
Surface modification III: N-(2-aminoethyl)-3-aminopropyltrimethoxysilane

TABLE 2

| | Examples [symbol] | | | | | | | | | Comparative Examples [symbol] | | | | | [symbol] |
|---|---|---|---|---|---|---|---|---|---|---|---|---|---|---|---|
| [symbol] | 1 [symbol] | 2 [symbol] | 3 [symbol] | 4 [symbol] | 5 [symbol] | 6 [symbol] | 7 [symbol] | 8 [symbol] | 9 [symbol] | 10 [symbol] | 11 [symbol] | 12 [symbol] | 13 [symbol] | 14 [symbol] | [symbol] |
| Rigid | 99.9 [symbol] | 99.8 [symbol] | 99.7 [symbol] | 99.8 [symbol] | 99.8 [symbol] | 99.7 [symbol] | 99.6 [symbol] | 99.8 [symbol] | 99.7 [symbol] | 99.9 [symbol] | 99.8 [symbol] | 99.7 [symbol] | 99.9 [symbol] | 100 [symbol] | [symbol] |
| poly- | | | | | | | | | | | | | | | |
| urethane | | | | | | | | | | | | | | | |
| foam [symbol] | | | | | | | | | | | | | | | |
| Fine | 0.1 [symbol] | 0.2 [symbol] | 0.3 [symbol] | 0.2 [symbol] | 0.2 [symbol] | 0.3 [symbol] | 0.4 [symbol] | — [symbol] | — [symbol] | — [symbol] | 0.2 [symbol] | 0.3 [symbol] | — [symbol] | — [symbol] | [symbol] |
| particles | | | | | | | | | | | | | | | |
| A [symbol] | | | | | | | | | | | | | | | |
| Fine | — [symbol] | — [symbol] | [symbol] — [symbol] | — [symbol] | — [symbol] | — [symbol] | — [symbol] | 0.2 [symbol] | 0.3 [symbol] | 0.1 [symbol] | — [symbol] | — [symbol] | 0.1 [symbol] | — [symbol] | [symbol] |
| particles | | | | | | | | | | | | | | | |
| B [symbol] | | | | | | | | | | | | | | | |
| Sum [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | 100 [symbol] | [symbol] |

[symbol]

indicates data missing or illegible when filed

The volume of the rigid polyurethane foam in Table 2 was calculated from the density of each rigid polyurethane foam and the total mass of the polyol, the foaming agent, and the isocyanate in Table 1.

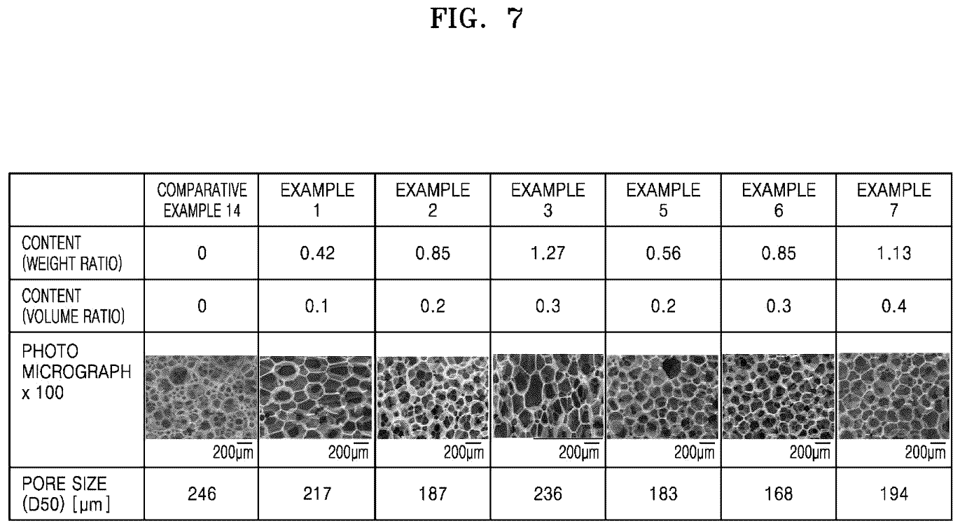

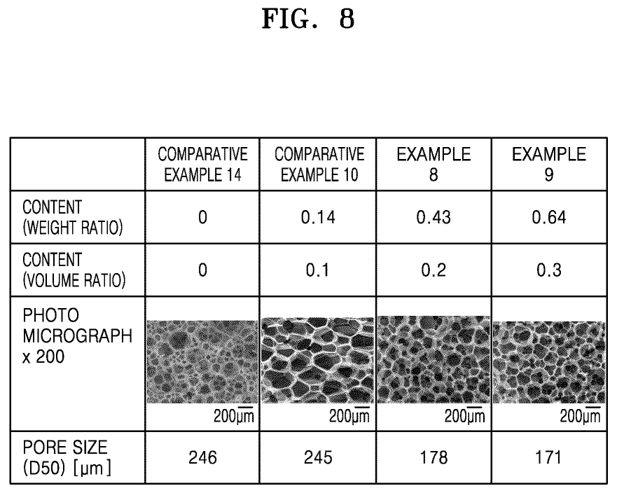

Next, the performance of Examples and Comparative Examples was evaluated through the following method. Results thereof are shown in Table 3. In addition, micrographs for Examples and Comparative Examples are shown in FIGS. 7 and 8.

### <Measurement of Thermal Conductivity>

For the rigid polyurethane foam containing fine particles or the rigid polyurethane foam not containing fine particles of each Example and Comparative Example after foaming and curing, by using a steady state thermal conductivity measuring device ((HFM436 manufactured by NETZSCH GmbH & Co.), the thermal conductivity of rigid polyurethane foam with a size of 300 mm×300 mm×thickness 30 mm was measured at an average temperature of 20° C.

### <Measurement of Pore Size>

By using a digital microscope (VHX-5000 manufactured by Keyence), pore diameters of 10 arbitrary pores within an observation field were measured, and a pore size (D50) was calculated from an average value of the pore diameters.

### <Measurement of Total Density of Rigid Polyurethane Foam Containing Fine Particles>

The weight of rigid polyurethane foam with a size of 300 mm×300 mm×thickness of 30 mm was measured by using an electronic scale, and the total density of the rigid polyurethane foam was calculated from the total volume of the rigid polyurethane foam.

TABLE 3

| | Examples [symbol] | | | | | | | |
|---|---|---|---|---|---|---|---|---|
| [symbol] | 1 [symbol] | 2 [symbol] | 3 [symbol] | 4 [symbol] | 5 [symbol] | 6 [symbol] | 7 [symbol] | 8 [symbol] |
| Surface modification | [symbol] [symbol] | [symbol] [symbol] | [symbol] [symbol] | [symbol] [symbol] | [symbol] [symbol] | [symbol] [symbol] | [symbol] [symbol] | [symbol] [symbol] |
| of fine particles [symbol] | | | | | | | | |
| Estimates number of | — [symbol] | 2.2 [symbol] | 3.2 [symbol] | 2.2 [symbol] | 3 [symbol] | 4.4 [symbol] | 5.9 [symbol] | 17,200 [symbol] |
| particles ( [symbol] ) [symbol] | | | | | | | | |
| Polyol- | [symbol] [symbol] | [symbol] [symbol] | [symbol] [symbol] | [symbol] [symbol] | [symbol] [symbol] | [symbol] [symbol] | [symbol] [symbol] | [symbol] [symbol] |
| compatability [symbol] | | | | | | | | |
| Density (kg/m²) [symbol] | 33.3 [symbol] | 33.7 [symbol] | 33.1 [symbol] | 33.7 [symbol] | 33 [symbol] | 33.2 [symbol] | 33 [symbol] | 33 [symbol] |
| Pore size (D50) | 217 [symbol] | 187 [symbol] | 236 [symbol] | 195 [symbol] | 183 [symbol] | 168 [symbol] | 194 [symbol] | 178 [symbol] |
| [μm] [symbol] | | | | | | | | |
| Thermal conductivity | 19.6 [symbol] | 19.4 [symbol] | 19.5 [symbol] | 19.5 [symbol] | 19.3 [symbol] | 19.2 [symbol] | 19.3 [symbol] | 19.3 [symbol] |
| @20° C. [symbol] | | | | | | | | |
| [symbol] | | | | | | | | |

| | Examples [symbol] | Comparative Examples [symbol] | | | | |
|---|---|---|---|---|---|---|
| [symbol] | 9 [symbol] | 10 [symbol] | 11 [symbol] | 12 [symbol] | 13 [symbol] | 14 [symbol] |
| Surface modification | [symbol] [symbol] | [symbol] [symbol] | [symbol] [symbol] | [symbol] [symbol] | [symbol] [symbol] | — [symbol] |
| of fine particles [symbol] | | | | | | |
| Estimates number of | 25,800 [symbol] | 8,600 [symbol] | 2.2 [symbol] | 3.2 [symbol] | 8,600 [symbol] | 0 [symbol] |
| particles ( [symbol] ) [symbol] | | | | | | |
| Polyol- | [symbol] [symbol] | [symbol] [symbol] | [symbol] [symbol] | [symbol] [symbol] | [symbol] [symbol] | [symbol] [symbol] |
| compatability [symbol] | | | | | | |
| Density (kg/m²) [symbol] | 33.7 [symbol] | 33.1 [symbol] | 33.1 [symbol] | 33.4 [symbol] | 33.1 [symbol] | 33.3 [symbol] |
| Pore size (D50) | 171 [symbol] | 245 [symbol] | 188 [symbol] | 170 [symbol] | 176 [symbol] | 24 [symbol] [symbol] |
| [μm] [symbol] | | | | | | |
| Thermal conductivity | 19.4 [symbol] | 19.9 [symbol] | 19.4 [symbol] | 19.4 [symbol] | 19.5 [symbol] | 19.8 [symbol] |
| @20° C. [symbol] | | | | | | |
| [symbol] | | | | | | |

[symbol]

indicates data missing or illegible when filed

From results of Examples and Comparative Examples shown in Table 3 and FIGS. 7 and 8, when a surface layer of the fine particles contained in the rigid polyurethane foam had both a hydrophobic group and a hydrophilic group as shown in Examples 1 to 9, in an operation of preparing a polyol premix, phase separation did not occur, and rigid polyurethane foam with a sufficient foaming ratio could be obtained, and also, thermal conductivity could be lowered as compared with a case in which fine particles were not added.

On the other hand, as shown in Comparative Examples 10 to 13, when a surface layer of the fine particles contained in the rigid polyurethane foam was hydrophobic, even when a content was 0.14 wt %, hydrophobic fine particles were separated from a polyol premix, and thus an effect of lowering thermal conductivity due to the addition of fine particles was not obtained. On the contrary, thermal conductivity was increased as compared with the case of Comparative Example 14 in which fine particles were not added. In addition, in Comparative Examples 11 to 13 in which a surface of the fine particles is hydrophilic, a polyol premix may be foamed and cured immediately after mixing, and thus thermal conductivity may be lowered. However, when a polyol premix of Comparative Examples 11 to 13 is left for 10 hours or more as in mass production, a hydrophobic foaming agent is separated from the polyol premix, resulting in an insufficient foaming ratio.

1. A refrigerator comprising:
a main body including:
an inner cabinet that forms a storage room,
an outer cabinet outside of the inner cabinet, and
an insulation material between the inner cabinet and the outer cabinet; and
a door configured to open and close the storage room,
wherein the insulation material includes a rigid polyurethane foam that includes:
fine particles that each include a surface layer including a hydrophobic group and a hydrophilic group, and
a urethane resin containing a constituent unit derived from polyol and a constituent unit derived from isocyanate.

2. The refrigerator of claim 1, wherein
the surface layer includes a modifying group chemically bonded to a surface of the fine particle, and
the modifying group, derived from a surface treatment agent, includes the hydrophobic group and the hydrophilic group.

3. The refrigerator of claim 1, wherein the hydrophilic group is an amino group or a hydroxyl group.

4. The refrigerator of claim 1, wherein the hydrophobic group is a C1-C10 straight-chain alkyl group.

5. The refrigerator of claim 1, wherein the hydrophilic group is between the hydrophobic group and the urethane resin.

6. The refrigerator of claim 1, wherein the hydrophobic group includes a C4-C10 aryl group.

7. The refrigerator of claim 1, wherein the fine particles include an inorganic material.

8. The refrigerator of claim 1, wherein the fine particles are hollow particles or porous particles.

9. The refrigerator of claim 2, wherein the surface treatment agent and the fine particles include silicon.

10. The refrigerator of claim 1, wherein
the fine particles each include:
a core,
a shell on the core, and
a surface layer on the shell, and
a density of the core is less than a density of the shell.

11. The refrigerator of claim 1, wherein
the rigid polyurethane foam includes:
a framework including the urethane resin, and
a plurality of pores defined by the framework, and
the fine particles are inside the framework and each fine particle is spaced apart from a pore of the plurality of pores by at least the urethane resin.

12. The refrigerator of claim 11, wherein the fine particles are each fixed inside the framework through a chemical bond with the urethane resin.

13. The refrigerator of claim 12, wherein the chemical bond includes a urea group, a urethane group, or a combination thereof.

14. The refrigerator of claim 1, wherein a content of the fine particles is in a range of 0.01 vol % to 0.5 vol % with respect to the rigid polyurethane foam.

15. The refrigerator of claim 1, wherein a content of the fine particles is in a range of 0.1 wt % to 1.5 wt % with respect to the rigid polyurethane foam.

16. The refrigerator of claim 1, wherein an average particle diameter of the fine particles is in a range of 0.03 μm to 20 μm.

17. The refrigerator of claim 1, wherein an apparent density of the fine particles is 200 kg/m³ or less.

18. The refrigerator of claim 1, wherein the rigid polyurethane foam further includes a foaming agent including an organic compound.

19. The refrigerator of claim 1, further including a cold air supply device configured to supply cold air to the storage room.

20. The refrigerator of claim 19, further comprising:
a machine room accommodating at least some parts of the cold air supply device; and
a processor configured to control the refrigerator.
